(19) United States
(12) Patent Application Publication
(10) Pub. No.: US 2017/0132264 A1
(43) Pub. Date: May 11, 2017

(54) Trajectory Data Query Method and Apparatus

(71) Applicant: Huawei Technologies Co., Ltd., Shenzhen (CN)

(72) Inventors: Yanhua Li, Shenzhen (CN); Chi-Yin Chow, Shenzhen (CN); Mingxuan Yuan, Hong Kong (CN); Qiang Yang, Shenzhen (CN)

(21) Appl. No.: 15/414,888

(22) Filed: Jan. 25, 2017

Related U.S. Application Data
(63) Continuation of application No. PCT/CN2014/083485, filed on Jul. 31, 2014.

(51) Int. Cl. G06F 17/30

(52) U.S. Cl. CPC G06F 17/30333; G06F 17/30327; G06F 17/30424

(57) ABSTRACT

A trajectory data query method includes establishing a spatial-temporal index and an inverted index for trajectory data in a spatial-temporal database, where the inverted index is used to form a first relationship correspondence table that includes a correspondence between each trajectory and its associated index leaf node; performing sampling for an index leaf node included in a space area specified by a user, where a quantity of index leaf nodes in the space area and a quantity of index leaf nodes obtained by sampling are determined; determining, according to the index leaf nodes obtained by sampling and the first relationship correspondence table, a correspondence between each trajectory included in the index leaf nodes obtained by sampling and an index leaf node associated with the trajectory, to form a second relationship correspondence table; and determining an unbiased estimation operator according to the quantity of index leaf nodes in the space area.

### CROSS-REFERENCE TO RELATED APPLICATIONS

This application is a continuation of International Application No. PCT/CN2014/083485, filed on Jul. 31, 2014, the disclosure of which is hereby incorporated by reference in its entirety.

### TECHNICAL FIELD

The present application relates to the field of database technologies, and in particular, to a trajectory data query method and apparatus.

### BACKGROUND

It is well known that a trajectory includes a series of geographical locations. However, with the development of science and technology, in addition to a characteristic of including geographical locations, the trajectory may further include a time label. That is, the trajectory may include a series of geographical locations with a time label. This may be theoretically understood as that “in three-dimensional space, one trajectory is constituted by multiple pieces of data that includes a time and a geographical location”. In addition, the data of the trajectory may be stored in a spatial-temporal database for a user to query.

Currently, a trajectory data query from a user may be implemented using a spatial-temporal index technology. First, a spatial-temporal index is established. As shown in FIG. 1, all trajectory data in a database is divided into small spatial-temporal areas, and each small spatial-temporal area (that is, a small cube shown in FIG. 1) is referred to as an index leaf node (index leaf node). Then, when trajectory data to be queried by the user is received, all leaf nodes in a related spatial-temporal area (that is, a big cube shown in FIG. 1) in the database are scanned and counted. By scanning, a statistical result of the trajectory data to be queried by the user can be obtained.

However, in the foregoing manner, a result required by the user can be obtained only by scanning a spatial-temporal area corresponding to the trajectory data to be queried by the user. When an amount of trajectory data to be queried by the user is huge, a spatial-temporal area corresponding to the trajectory data to be queried by the user is also huge, and it needs to take a very long time to scan the huge spatial-temporal area.

### SUMMARY

Embodiments of the present application provide a trajectory data query method and apparatus, which can greatly shorten a trajectory data query time.

A first aspect of the present application provides a trajectory data query method, where the method includes establishing a spatial-temporal index and an inverted index (Inverted Index) for trajectory data in a spatial-temporal database, where the inverted index is used to form a first relationship correspondence table that includes a correspondence between each trajectory and its associated index leaf node, and forms of an association between each trajectory and its associated index leaf node include a middle portion of the trajectory passes through an index leaf node, the beginning or end of the trajectory is in an index leaf node, and the trajectory is completely in an index leaf node; receiving a trajectory data query from a user, where the trajectory data query from the user includes specifying, by the user, a space area in the spatial-temporal database, to count a result of data in the space area; performing sampling for an index leaf node included in the specified space area, where a quantity of index leaf nodes in the space area and a quantity of index leaf nodes obtained by sampling are determined; determining, according to the index leaf nodes obtained by sampling and the first relationship correspondence table, a correspondence between each trajectory included in the index leaf nodes obtained by sampling and an index leaf node associated with the trajectory, to form a second relationship correspondence table; and determining an unbiased estimation operator according to the quantity of index leaf nodes in the space area, the quantity of index leaf nodes obtained by sampling, and data in the second relationship correspondence table, and determining a query result by means of calculation.

In a first possible implementation manner of the first aspect, the forming a first relationship correspondence table that includes a correspondence between each trajectory and its associated index leaf node includes determining all index leaf nodes in the spatial-temporal database by means of the spatial-temporal index; determining, based on each trajectory in the spatial-temporal database, an index leaf node associated with each trajectory; and storing the correspondence between each trajectory and its associated index leaf node to form the first relationship correspondence table.

With reference to the first aspect or the first possible implementation manner of the first aspect, in a second possible implementation manner of the first aspect, the performing sampling for an index leaf node included in the space area, where a quantity of index leaf nodes in the space area and a quantity of index leaf nodes obtained by sampling are determined is performing random sampling with replacement for n index leaf nodes included in the specified space area, to obtain B repeatable index leaf nodes, where n>B, and both n and B are positive integers.

With reference to the first aspect, or the first possible implementation manner of the first aspect, or the second possible implementation manner of the first aspect, in a third possible implementation manner of the first aspect, the determining, according to the index leaf nodes obtained by sampling and the first relationship correspondence table, a correspondence between each trajectory included in the index leaf nodes obtained by sampling and an index leaf node associated with the trajectory, to form a second relationship correspondence table includes listing, according to the index leaf nodes obtained by sampling, multiple trajectories included in the index leaf nodes; obtaining, from the first relationship correspondence table, at least one index leaf node associated with each trajectory in the multiple trajectories; and determining whether the at least one index leaf node exists among the index leaf nodes obtained by sampling, and if a determining result is that the at least one index leaf node exists among the index leaf nodes obtained by sampling, reserving an index leaf node corresponding to the trajectory, and recording, in the second relationship correspondence table, a correspondence between the index leaf node and the trajectory.

With reference to the third possible implementation manner of the first aspect, in a fourth possible implementation manner of the first aspect, after the listing, according to the index leaf nodes obtained by sampling, multiple trajectories included in the index leaf nodes, the method further includes determining whether a recurring trajectory exists among the multiple trajectories that are listed, and if a trajectory recurs, skipping listing the recurring trajectory, to ensure that multiple non-repeated trajectories are obtained; and in this case, the obtaining, from the first relationship correspondence table, at least one index leaf node associated with each trajectory in the multiple trajectories is obtaining, from the first relationship correspondence table, at least one index leaf node associated with each trajectory in the multiple non-repeated trajectories.

With reference to any one of the first aspect, or the foregoing possible implementation manners of the first aspect, in a fifth possible implementation manner of the first aspect the determining an unbiased estimation operator according to the quantity of index leaf nodes in the space area, the quantity of index leaf nodes obtained by sampling, and data in the second relationship correspondence table, and determining a query result by means of calculation includes calculating a quantity of index leaf nodes corresponding to each trajectory in the second relationship correspondence table; and determining the unbiased estimation operator according to the quantity of index leaf nodes in the space area, the quantity of index leaf nodes obtained by sampling, a quantity of trajectories in the second relationship correspondence table, and a quantity of corresponding index leaf nodes that each trajectory passes through in the spatial-temporal area, and with reference to a probability statistical method and a law of large numbers, and determining the query result by means of calculation according to the unbiased estimation operator, where the determining the unbiased estimation operator with reference to a probability statistical method and a law of large numbers is determining a real value expression that includes information about all the leaf nodes in the specified area; and then, performing sampling for all the leaf nodes in the specified area, and determining the unbiased estimation operator using information about the leaf nodes obtained by sampling, and with reference to the law of large numbers, to estimate a real value obtained using the real value expression.

With reference to the fifth possible implementation manner of the first aspect, in a sixth possible implementation manner of the first aspect, when the trajectory data query from the user is a trajectory count query, the following unbiased estimation operator is determined, and a query result is determined by means of calculation:

$${\hat{N}}_{q} = \frac{n}{B} {\sum }_{t = 1}^{B} {f}_{q} {( {R}_{t} )}^{{\hat{}}^{q}} , \\ where {f}_{q} {( {R}_{t} )}^{{\hat{}}^{q}} = {\sum }_{r ∈ {{R}_{t}}^{{\hat{}}^{q}} \hat{} q} \{ 1 / {k}_{r}^{q} \} ,$$

where q represents a spatial-temporal area related to a query range of the user; n represents a quantity of all leaf nodes in the spatial-temporal area q before sampling; B represents a quantity of leaf nodes after the sampling; r represents a trajectory obtained according to the B index leaf nodes and a second relationship correspondence table obtained after the sampling; and kᵣ^{q} represents a quantity of index leaf nodes that the trajectory r passes through in the queried spatial-temporal area q.

With reference to the fifth possible implementation manner of the first aspect, in a seventh possible implementation manner of the first aspect, when the trajectory data query from the user is a trajectory characteristic query, the following unbiased estimation operator is determined, and a query result is determined by means of calculation:

$${\hat{l}}_{q} = \frac{n}{B} {\sum }_{t = 1}^{B} {h}_{q} {( {R}_{t} )}^{{\hat{}}^{q}} , \\ where {h}_{q} {( {R}_{t} )}^{{\hat{}}^{q}} = {\sum }_{r ∈ {{R}_{t}}^{{\hat{}}^{q}}} {l}_{r} / {k}_{r}^{q} ,$$

where q represents a spatial-temporal area related to a query range of the user; n represents a quantity of all leaf nodes in the spatial-temporal area q before sampling; B represents a quantity of leaf nodes after the sampling; r represents a trajectory obtained according to the B index leaf nodes and a second relationship correspondence table obtained after the sampling; lᵣ represents a trajectory characteristic of the trajectory r; and kᵣ^{q} represents a quantity of index leaf nodes that the trajectory r passes through in the queried spatial-temporal area q.

With reference to the fifth possible implementation manner of the first aspect, in an eighth possible implementation manner of the first aspect. when the trajectory data query from the user is a query for an average trajectory characteristic value, the following unbiased estimation operator is determined, and a query result is determined by means of calculation:

$${\hat{L}}_{q} = \frac{{\sum }_{t = 1}^{B} {h}_{q} {( {R}_{t} )}^{{\hat{}}^{q}}}{{\sum }_{t = 1}^{B} {f}_{q} {( {R}_{t} )}^{{\hat{}}^{q}}} , where$$

$${\hat{N}}_{q} = {f}_{q} {( {R}_{t} )}^{{\hat{}}^{q}} = {\sum }_{r ∈ {{R}_{t} \hat{} q}^{{\hat{}}^{q}}} \{ 1 / {k}_{r}^{q} \} , {h}_{q} {( {R}_{t} )}^{{\hat{}}^{q}} = {\sum }_{r ∈ {{R}_{t}}^{{\hat{}}^{q}}} {l}_{r} / {k}_{r}^{q} ,$$

where q represents a spatial-temporal area related to a query range of the user; n represents a quantity of all leaf nodes in the spatial-temporal area q before sampling; B represents a quantity of leaf nodes after the sampling; r represents a trajectory obtained according to the B index leaf nodes and a second relationship correspondence table obtained after the sampling; lᵣ represents a trajectory characteristic of the trajectory r; and kᵣ^{q} represents a quantity of index leaf nodes that the trajectory r passes through in the queried spatial-temporal area q.

A second aspect of the present application provides a trajectory data query apparatus, where the apparatus includes an establishing unit configured to establish a spatial-temporal index and an inverted index for trajectory data in a spatial-temporal database, where the inverted index is used to form a first relationship correspondence table that includes a correspondence between each trajectory and its associated index leaf node, and forms of an association between each trajectory and its associated index leaf node include a middle portion of the trajectory passes through an index leaf node, the beginning or end of the trajectory is in an index leaf node, and the trajectory is completely in an index leaf node; a receiving unit configured to receive a trajectory data query from a user, where the trajectory data query from the user includes specifying, by the user, a space area in the spatial-temporal database, to count a result of data in the space area; a sampling unit configured to perform sampling for an index leaf node included in the specified space area, where a quantity of index leaf nodes in the space area and a quantity of index leaf nodes obtained by sampling are determined; and a determining unit configured to determine, according to the index leaf nodes obtained by sampling by the sampling unit and the first relationship correspondence table, a correspondence between each trajectory included in the index leaf nodes obtained by sampling and an index leaf node associated with the trajectory, to form a second relationship correspondence table, and configured to determine an unbiased estimation operator according to the quantity of index leaf nodes in the space area, the quantity of index leaf nodes obtained by sampling, and data in the second relationship correspondence table, and determine a query result by means of calculation.

In a first possible implementation manner of the second aspect, the establishing unit is configured to determine all index leaf nodes in the spatial-temporal database by means of the spatial-temporal index; determine, based on each trajectory in the spatial-temporal database, an index leaf node associated with each trajectory; and store the correspondence between each trajectory and its associated index leaf node to form the first relationship correspondence table.

With reference to the second aspect or the first possible implementation manner of the second aspect, in a second possible implementation manner of the second aspect, the sampling unit is configured to perform random sampling with replacement for n index leaf nodes included in the specified space area, to obtain B repeatable index leaf nodes, where n>B, and both n and B are positive integers.

With reference to the second aspect, or the first possible implementation manner of the second aspect, or the second possible implementation manner of the second aspect, in a third possible implementation manner of the second aspect, the determining unit includes a determining module configured to list, according to the index leaf nodes obtained by sampling, multiple trajectories included in the index leaf nodes; an obtaining module configured to obtain, from the first relationship correspondence table, at least one index leaf node associated with each trajectory in the multiple trajectories; and a judging module configured to determine whether the at least one index leaf node obtained by the obtaining module exists among the index leaf nodes obtained by sampling by the sampling unit, and if a determining result is that the at least one index leaf node obtained by the obtaining module exists among the index leaf nodes obtained by sampling by the sampling unit, reserve an index leaf node corresponding to the trajectory, and record, in the second relationship correspondence table, a correspondence between the index leaf node and the trajectory.

With reference to the third possible implementation manner of the second aspect, in a fourth possible implementation manner of the second aspect, the determining module is further configured to determine whether a recurring trajectory exists among the multiple trajectories that are listed, and if a trajectory recurs, skip listing the recurring trajectory, to ensure that multiple non-repeated trajectories are obtained; and in this case, the obtaining module is configured to obtain, from the first relationship correspondence table, at least one index leaf node associated with each trajectory in the multiple non-repeated trajectories determined by the determining module.

With reference to any one of the second aspect, or the foregoing possible implementation manners of the second aspect, in a fifth possible implementation manner of the second aspect, the determining unit is configured to calculate a quantity of index leaf nodes corresponding to each trajectory in the second relationship correspondence table; and determine the unbiased estimation operator according to the quantity of index leaf nodes in the space area, the quantity of index leaf nodes obtained by sampling, a quantity of trajectories in the second relationship correspondence table, and a quantity of corresponding index leaf nodes that each trajectory passes through in the spatial-temporal area, and with reference to a probability statistical method and a law of large numbers, and determine the query result by means of calculation according to the unbiased estimation operator, where the determining the unbiased estimation operator with reference to a probability statistical method and a law of large numbers is determining a real value expression that includes information about all the leaf nodes in the specified area; and then, performing sampling for all the leaf nodes in the specified area, and determining the unbiased estimation operator using information about the leaf nodes obtained by sampling, and with reference to the law of large numbers, to estimate a real value obtained using the real value expression.

A third aspect of the present application provides a trajectory data query apparatus, where the apparatus includes a processor configured to establish a spatial-temporal index and an inverted index for trajectory data in a spatial-temporal database, where the inverted index is used to form a first relationship correspondence table that includes a correspondence between each trajectory and its associated index leaf node, and forms of an association between each trajectory and its associated index leaf node include a middle portion of the trajectory passes through an index leaf node, the beginning or end of the trajectory is in an index leaf node, and the trajectory is completely in an index leaf node; and a receiver configured to receive a trajectory data query from a user, where the trajectory data query from the user includes specifying, by the user, a space area in the spatial-temporal database, to count a result of data in the space area, where the processor is further configured to perform sampling for an index leaf node included in the specified space area, where a quantity of index leaf nodes in the space area and a quantity of index leaf nodes obtained by sampling are determined, and determine, according to the index leaf nodes obtained by sampling by the sampling unit and the first relationship correspondence table, a correspondence between each trajectory included in the index leaf nodes obtained by sampling and an index leaf node associated with the trajectory, to form a second relationship correspondence table; and configured to determine an unbiased estimation operator according to the quantity of index leaf nodes in the space area, the quantity of index leaf nodes obtained by sampling, and data in the second relationship correspondence table, and determine a query result by means of calculation.

In a first possible implementation manner of the third aspect, the processor is configured to determine all index leaf nodes in the spatial-temporal database by means of the spatial-temporal index; determine, based on each trajectory in the spatial-temporal database, an index leaf node associated with each trajectory; and store the correspondence between each trajectory and its associated index leaf node to form the first relationship correspondence table.

With reference to the third aspect or the first possible implementation manner of the third aspect, in a second possible implementation manner of the third aspect, the processor is configured to perform random sampling with replacement for n index leaf nodes included in the specified space area, to obtain B repeatable index leaf nodes, where n>B, and both n and B are positive integers.

With reference to the third aspect, or the first possible implementation manner of the third aspect, or the second possible implementation manner of the third aspect, in a third possible implementation manner of the third aspect, the processor is configured to list, according to the index leaf nodes obtained by sampling, multiple trajectories included in the index leaf nodes; obtain, from the first relationship correspondence table, at least one index leaf node associated with each trajectory in the multiple trajectories; and determine whether the at least one index leaf node obtained by the obtaining module exists among the index leaf nodes obtained by sampling by the sampling unit, and if a determining result is that the at least one index leaf node obtained by the obtaining module exists among the index leaf nodes obtained by sampling by the sampling unit, reserve an index leaf node corresponding to the trajectory, and record, in the second relationship correspondence table, a correspondence between the index leaf node and the trajectory.

With reference to the third possible implementation manner of the third aspect, in a fourth possible implementation manner of the third aspect, the processor is configured to determine whether a recurring trajectory exists among the multiple trajectories that are listed, and if a trajectory recurs, skip listing the recurring trajectory, to ensure that multiple non-repeated trajectories are obtained; and obtain, from the first relationship correspondence table, at least one index leaf node associated with each trajectory in the multiple non-repeated trajectories determined by the determining module.

With reference to any one of the third aspect, or the foregoing possible implementation manners of the third aspect, in a fifth possible implementation manner of the third aspect, the processor is configured to calculate a quantity of index leaf nodes corresponding to each trajectory in the second relationship correspondence table; and determine the unbiased estimation operator according to the quantity of index leaf nodes in the space area, the quantity of index leaf nodes obtained by sampling, a quantity of trajectories in the second relationship correspondence table, and a quantity of corresponding index leaf nodes that each trajectory passes through in the spatial-temporal area, and with reference to a probability statistical method and a law of large numbers, and determine the query result by means of calculation according to the unbiased estimation operator, where the determining the unbiased estimation operator with reference to a probability statistical method and a law of large numbers is determining a real value expression that includes information about all the leaf nodes in the specified area; then, performing sampling for all the leaf nodes in the specified area, and determining the unbiased estimation operator using information about the leaf nodes obtained by sampling, and with reference to the law of large numbers, to estimate a real value obtained using the real value expression.

According to the trajectory data query method and apparatus that are provided in the present application, a spatial-temporal index and an inverted index are established for trajectory data in a spatial-temporal database, where the inverted index is used to form a first relationship correspondence table that includes a correspondence between each trajectory and its associated index leaf node; a trajectory data query from a user is received, where the trajectory data query from the user includes specifying, by the user, a space area in the spatial-temporal database; sampling is performed for an index leaf node included in the specified space area, where a quantity of index leaf nodes in the space area and a quantity of index leaf nodes obtained by sampling are determined; a correspondence between each trajectory included in the index leaf nodes obtained by sampling and an index leaf node associated with the trajectory is determined according to the index leaf nodes obtained by sampling and the first relationship correspondence table, to form a second relationship correspondence table; and a query result is determined according to the quantity of index leaf nodes in the space area, the quantity of index leaf nodes obtained by sampling, and data in the second relationship correspondence table. It can be seen from the above that, in addition to a spatial-temporal index, an inverted index is also established in the present application. Therefore, according to the two indexes, a correspondence between a trajectory included in index leaf nodes obtained by sampling and an index leaf node associated with the trajectory can be determined, that is, a second relationship correspondence table is formed; and further, an unbiased estimation operator can be determined according to a quantity of index leaf nodes in a space area, a quantity of index leaf nodes obtained by sampling, and data in the second relationship correspondence table, and a query result can be determined by means of calculation. This manner in which a spatial-temporal index and an inverted index are established and that is based on sampling can avoid scanning all trajectory data in a query-related spatial-temporal area, thereby shortening a query time, improving query efficiency, and saving a system resource. In addition, a query result determined by means of calculation using an unbiased estimation operator has relatively high accuracy.

### BRIEF DESCRIPTION OF DRAWINGS

To describe the technical solutions in the embodiments of the present application or in the prior art more clearly, the following briefly describes the accompanying drawings required for describing the embodiments or the prior art. The accompanying drawings in the following description show merely some embodiments of the present application, and a person of ordinary skill in the art may still derive other drawings from these accompanying drawings without creative efforts.

FIG. 1 is an exemplary schematic diagram of establishing a spatial-temporal index in the prior art;

FIG. 2 is a schematic flowchart of a trajectory data query method according to Embodiment 1 of the present application;

FIG. 3 is a schematic flowchart of a trajectory data query method according to Embodiment 2 of the present application;

FIG. 4 is a schematic structural diagram of a trajectory data query apparatus according to Embodiment 3 of the present application;

FIG. 5 is another schematic structural diagram of a trajectory data query apparatus according to Embodiment 3 of the present application;

FIG. 6 is a schematic structural diagram of a trajectory data query apparatus according to Embodiment 4 of the present application; and

FIG. 7 is another schematic structural diagram of a trajectory data query apparatus according to Embodiment 4 of the present application.

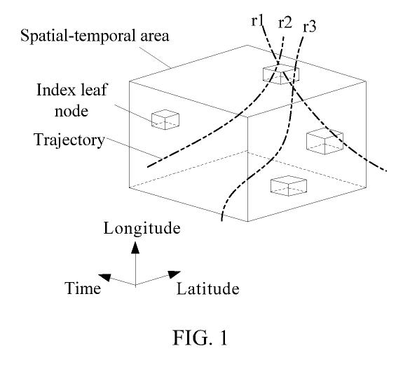

### DESCRIPTION OF EMBODIMENTS

The following clearly describes the technical solutions in the embodiments of the present application with reference to the accompanying drawings in the embodiments of the present application. The described embodiments are merely a part rather than all of the embodiments of the present application. All other embodiments obtained by a person of ordinary skill in the art based on the embodiments of the present application without creative efforts shall fall within the protection scope of the present application.

First, it should be noted that multiple space-time points exist in a spatial-temporal database. The space-time point has time and space information about time, longitude, and latitude, and the space-time point also has identification information. In this way, space-time points with same identification information may form a trajectory. In addition, an index leaf node also exists in the spatial-temporal database. The index leaf node is a human-specified minimum-unit space area. The index leaf node includes multiple space-time points within a time range. Because the space-time point has the time and space information about the time, the longitude, and the latitude, the index leaf node also has such time and space information.

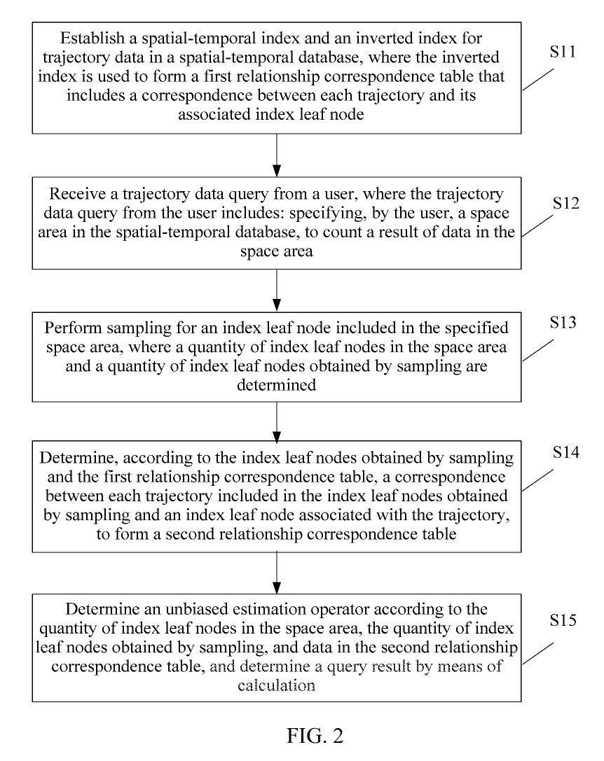

Embodiment 1 of the present application provides a trajectory data query method. As shown in FIG. 2, the method includes the following steps.

S11: Establish a spatial-temporal index and an inverted index for trajectory data in a spatial-temporal database, where the inverted index is used to form a first relationship correspondence table that includes a correspondence between each trajectory and its associated index leaf node.

In this step, forms of an association between “each trajectory and its associated index leaf node” may include the following three forms: a first form in which a trajectory passes through an index leaf node, that is, a middle portion of the trajectory is in the index leaf node; a second form in which the beginning or end of a trajectory is in an index leaf node; and a third form in which a trajectory is completely in an index leaf node.

In this step, because the trajectory data has time and space characteristics, an index needs to be established before the trajectory data is queried. In the prior art, only a spatial-temporal index is established, and is used to determine all index leaf nodes in the database. An index establishing method may adopt a method such as Quad-tree, B-tree, or B+-tree. However, in the present application, in addition to the spatial index, an inverted index is also established. The inverted index is used to form the first relationship correspondence table that includes the correspondence between each trajectory and its associated index leaf node.

Optionally, in a specific embodiment of the present application, a step of establishing the inverted index to form the first relationship correspondence table that includes the correspondence between each trajectory and its associated index leaf node may be divided into the following steps.

111: Determine all index leaf nodes in the database by means of the spatial-temporal index.

112: Determine, based on each trajectory in the spatial-temporal database, an index leaf node associated with each trajectory.

It may be understood that each trajectory in the spatial-temporal database may cross at least one index leaf node, and generally, one trajectory cannot cross all the index leaf nodes in the spatial-temporal database. Therefore, an index leaf node associated with each trajectory needs to be determined.

113: Store the correspondence between each trajectory and its associated index leaf node to form the first relationship correspondence table.

In step 113, each index leaf node further has ID information. That is, a corresponding identity (ID) may be set for each index leaf node. Therefore, in the first relationship correspondence table, the correspondence between each trajectory and its associated index leaf node is a correspondence between each trajectory and an ID of at least one index leaf node associated with the trajectory.

It should be noted that, by means of the foregoing establishment of the inverted index, a correspondence between each trajectory in the spatial-temporal database and an index leaf node associated with the trajectory can be obtained.

It may be understood that the foregoing spatial index and inverted index are not re-established before each query. That is, once the spatial index and the inverted index are established, index data established using the spatial index and the inverted index is stored. The stored data may be applied to multiple queries, thereby saving a query time. Certainly, a person skilled in the art may regularly update and establish the spatial index and the inverted index according to experience, which is not limited herein in the present application.

S12: Receive a trajectory data query from a user, where the trajectory data query from the user includes specifying, by the user, a space area in the spatial-temporal database, to count a result of data in the space area.

In this step, the trajectory data query from the user usually includes a query range and a query object. For example, if the trajectory data query from the user is “a quantity of taxi passenger trajectories in Beijing in 2013”, “in 2013” and “in Beijing” are the query range, and “a quantity of taxi passenger trajectories” is the query object. It may be understood that, when the user gives a query range, a certain space area in the spatial-temporal database is also specified for a query.

S13: Perform sampling for an index leaf node included in the specified space area, where a quantity of index leaf nodes in the space area and a quantity of index leaf nodes obtained by sampling are determined.

Optionally, in a specific embodiment of the present application, step S13 includes performing random sampling with replacement for n index leaf nodes included in the determined space area, to obtain B repeatable index leaf nodes, where n>B, and both n and B are positive integers.

Therefore, an index leaf node obtained by sampling each time is placed back to an original space area after being recorded, so that the quantity of index leaf nodes in the space area is always n for each sampling.

A sampling method may be any sampling algorithm. In addition to the random sampling with replacement in this embodiment of the present application, another sampling manner may be adopted, for example, biased sampling with replacement or biased sampling without replacement.

S14: Determine, according to the index leaf nodes obtained by sampling and the first relationship correspondence table, a correspondence between each trajectory included in the index leaf nodes obtained by sampling and an index leaf node associated with the trajectory, to form a second relationship correspondence table.

It should be noted that, in this embodiment of the present application, the second relationship correspondence table is dynamically formed. That is, when the user performs a different query for the trajectory data, content in a generated second relationship correspondence table is also different. Therefore, it may be understood that this embodiment of the present application focuses on how to generate the second relationship correspondence table, rather than the second relationship correspondence table itself.

Optionally, in a specific embodiment of the present application, step S14 includes the following steps.

141: List, according to the index leaf nodes obtained by sampling, multiple trajectories included in the index leaf nodes.

142: Obtain, from the first relationship correspondence table, at least one index leaf node associated with each trajectory in the multiple trajectories.

143: Determine whether the at least one index leaf node exists among the index leaf nodes obtained by sampling, and if a determining result is that the at least one index leaf node exists among the index leaf nodes obtained by sampling, reserve an index leaf node corresponding to the trajectory, and record, in the second relationship correspondence table, a correspondence between the index leaf node and the trajectory.

It should be noted that, for the obtaining, from the first relationship correspondence table, at least one index leaf node associated with each trajectory in the multiple trajectories, the index leaf node may be located inside the spatial-temporal area, or may be located outside the spatial-temporal area, and after the foregoing determining process, only the index leaf node in the spatial-temporal area is reserved.

Further, in a specific embodiment of the present application, after the foregoing step 141, the following step may be further included: determining whether a recurring trajectory exists among the multiple trajectories that are listed, and if a trajectory recurs, skipping listing the recurring trajectory, to ensure that multiple non-repeated trajectories are obtained.

In this case, step 142 is obtaining, from the first relationship correspondence table, at least one index leaf node associated with each trajectory in the multiple non-repeated trajectories.

It should be noted that, in the foregoing step of eliminating a recurring trajectory, the number of times of determining “whether the at least one index leaf node exists among the index leaf nodes obtained by sampling” in step 143 may be reduced, thereby shortening a determining time and improving efficiency.

S15: Determine an unbiased estimation operator according to the quantity of index leaf nodes in the space area, the quantity of index leaf nodes obtained by sampling, and data in the second relationship correspondence table, and determine a query result by means of calculation.

Optionally, in a specific embodiment of the present application, step S15 includes the following steps.

151: Calculate a quantity of index leaf nodes corresponding to each trajectory in the second relationship correspondence table.

152: Determine the unbiased estimation operator according to the quantity of index leaf nodes in the space area, the quantity of index leaf nodes obtained by sampling, a quantity of trajectories in the second relationship correspondence table, and a quantity of corresponding index leaf nodes that each trajectory passes through in the spatial-temporal area, and with reference to a probability statistical method and a law of large numbers, and determine the query result by means of calculation according to the unbiased estimation operator. The determining the unbiased estimation operator with reference to a probability statistical method and a law of large numbers is divided into the following steps: first, determining a real value expression that includes information about all the leaf nodes in the specified area; and then, performing sampling for all the leaf nodes in the specified area, and determining the unbiased estimation operator using information about the leaf nodes obtained by sampling, and with reference to the law of large numbers, to estimate a real value obtained using the real value expression.

It should be noted that the unbiased estimation operator may be pre-determined as in the foregoing steps, and once the unbiased estimation operator is determined, the unbiased estimation operator can be directly applied to a subsequent same or similar query.

When a formula in step 152 uses unbiased estimation in calculation, it is proved by trials performed by the inventor that an accuracy rate of a query result determined by utilizing trajectory data obtained by sampling reaches 95% or above. Therefore, a query result determined by performing unbiased estimation for sampling data has relatively high accuracy.

It may be understood that, in this embodiment of the present application, biased estimation or another estimation operator may be adopted, which is not limited in the present application.

Optionally, in a specific embodiment of the present application, when the trajectory data query from the user is a trajectory count query (Count Query), the following unbiased estimation operator is determined, and a query result is determined by means of calculation:

$${\hat{N}}_{q} = \frac{n}{B} {\sum }_{t = 1}^{B} {f}_{q} {( {R}_{t} )}^{{\hat{}}^{q}} ; \\ where {f}_{q} {( {R}_{t} )}^{{\hat{}}^{q}} = {\sum }_{r ∈ {{R}_{t}}^{{\hat{}}^{q}} \hat{} q} \{ 1 / {k}_{r}^{q} \} , \qquad ( 1 )$$

where q represents a spatial-temporal area related to a query range of the user; n represents a quantity of all index leaf nodes in the spatial-temporal area q before sampling; B represents a quantity of index leaf nodes after the sampling, and in particular, when a sampling manner is the random sampling with replacement, the B leaf nodes may be repeatable, that is, each sampled leaf node is independently and randomly selected from all the leaf nodes in q; r represents a trajectory obtained according to the B index leaf nodes and a second relationship correspondence table obtained after the sampling; and kᵣ^{q} represents a quantity of index leaf nodes that the trajectory r passes through in the queried spatial-temporal area q.

Optionally, in a specific embodiment of the present application, when the trajectory data query from the user is a trajectory characteristic query (Sum Query), the following unbiased estimation operator is determined, and a query result is determined by means of calculation:

$${\hat{l}}_{q} = \frac{n}{B} {\sum }_{t = 1}^{B} {h}_{q} {( {R}_{t} )}^{{\hat{}}^{q}} ; \\ where {h}_{q} {( {R}_{t} )}^{{\hat{}}^{q}} = {\sum }_{r ∈ {{R}_{t}}^{{\hat{}}^{q}}} {l}_{r} / {k}_{r}^{q} , \qquad ( 2 )$$

where q represents a spatial-temporal area related to a query range of the user; n represents a quantity of all leaf nodes in the spatial-temporal area q before sampling; B represents a quantity of leaf nodes after the sampling, and in particular, when a sampling manner is the random sampling with replacement, the B leaf nodes may be repeatable, that is, each sampled leaf node is independently and randomly selected from all the leaf nodes in q; r represents a trajectory obtained according to the B index leaf nodes and a second relationship correspondence table obtained after the sampling; lᵣ represents a trajectory characteristic of the trajectory r, where the trajectory characteristic is a statistical characteristic of a trajectory, for example, a quantity of kilometers, a quantity of crossed blocks, or lasting duration; and kᵣ^{q} represents a quantity of index leaf nodes that the trajectory r passes through in the queried spatial-temporal area q.

Optionally, in a specific embodiment of the present application, when the trajectory data query from the user is a query for an average trajectory characteristic value (Average Query), the following unbiased estimation operator is determined, and a query result is determined by means of calculation:

$${\hat{L}}_{q} = \frac{{\sum }_{t = 1}^{B} {h}_{q} {( {R}_{t} )}^{{\hat{}}^{q}}}{{\sum }_{t = 1}^{B} {f}_{q} {( {R}_{t} )}^{{\hat{}}^{q}}} ; where \\ {\hat{N}}_{q} = {f}_{q} {( {R}_{t} )}^{{\hat{}}^{q}} = {\sum }_{r ∈ {{R}_{t}}^{{\hat{}}^{q}} \hat{} q} \{ 1 / {k}_{r}^{q} \} , {h}_{q} {( {R}_{t} )}^{{\hat{}}^{q}} = {\sum }_{r ∈ {{R}_{t}}^{{\hat{}}^{q}}} {l}_{r} / {k}_{r}^{q} , \qquad ( 3 )$$

where q represents a spatial-temporal area related to a query range of the user; n represents a quantity of all leaf nodes in the spatial-temporal area q before sampling; B represents a quantity of leaf nodes after the sampling, and in particular, when a sampling manner is the random sampling with replacement, the B leaf nodes may be repeatable, that is, each sampled leaf node is independently and randomly selected from all the leaf nodes in q; r represents a trajectory obtained according to the B index leaf nodes and a second relationship correspondence table obtained after the sampling; lᵣ represents a trajectory characteristic of the trajectory r, where the trajectory characteristic is a statistical characteristic of a trajectory, for example, a quantity of kilometers, a quantity of crossed blocks, or lasting duration; and kᵣ^{q} represents a quantity of index leaf nodes that the trajectory r passes through in the queried spatial-temporal area q.

According to the trajectory data query method provided in Embodiment 1 of the present application, a spatial-temporal index and an inverted index are established for trajectory data in a spatial-temporal database, where the inverted index is used to form a first relationship correspondence table that includes a correspondence between each trajectory and its associated index leaf node; a trajectory data query from a user is received, where the trajectory data query from the user includes specifying, by the user, a space area in the spatial-temporal database; sampling is performed for an index leaf node included in the specified space area, where a quantity of index leaf nodes in the space area and a quantity of index leaf nodes obtained by sampling are determined; a correspondence between each trajectory included in the index leaf nodes obtained by sampling and an index leaf node associated with the trajectory is determined according to the index leaf nodes obtained by sampling and the first relationship correspondence table, to form a second relationship correspondence table; and an unbiased estimation operator is determined according to the quantity of index leaf nodes in the space area, the quantity of index leaf nodes obtained by sampling, and data in the second relationship correspondence table, and a query result is determined by means of calculation. It can be seen from the above that, in addition to a spatial-temporal index, an inverted index is also established in the present application. Therefore, according to the two indexes, a correspondence between a trajectory included in index leaf nodes obtained by sampling and an index leaf node associated with the trajectory can be determined, that is, a second relationship correspondence table is formed; and further a query result can be determined according to a quantity of index leaf nodes in a space area, a quantity of index leaf nodes obtained by sampling, and data in the second relationship correspondence table. This manner in which a spatial-temporal index and an inverted index are established and that is based on sampling can avoid scanning all trajectory data in a query-related spatial-temporal area, thereby shortening a query time, improving query efficiency, and saving a system resource. In addition, a query result determined by means of calculation using an unbiased estimation operator has relatively high accuracy.

It should be noted that an application scenario in this embodiment of the present application is not limited to querying some trajectory data from the spatial-temporal database, and may also be a scenario related to a trajectory data query. For example, when a carrier wants to provide, by utilizing trajectory data, a shop location service for an entity shop of another industry, for example, McDonald. If McDonald requires that a shop be located at a place with a largest flow of people, fast trajectory query can be used to quickly select several target areas and provide a suggestion and a plan for the shop to select an address. In addition, a traffic planning department may query, based on a city's taxi trajectory data, for distribution of taxi demands in each spatial-temporal area of the city, to find a place at which a taxi stand should be built.

### Embodiment 2

To make a person skilled in the art have a better understanding of a technical solution of the trajectory data query method provided in the embodiments of the present application, the trajectory data query method provided in the present application is described in detail below using a specific embodiment and using a trajectory count query as an example.

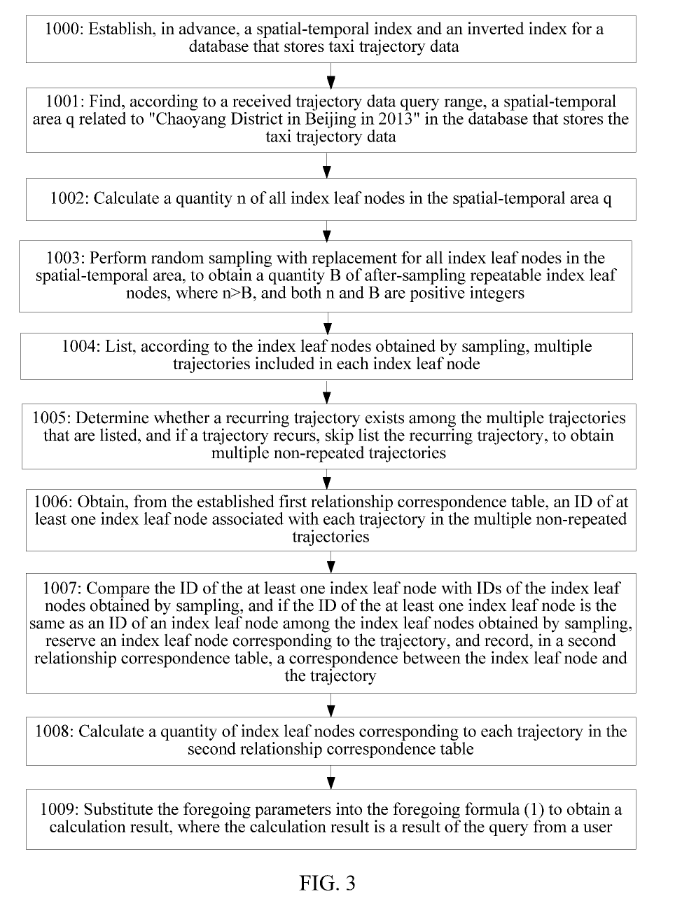

When a trajectory data query delivered by a user is “querying a quantity of all taxi passenger trajectories in Chaoyang District in Beijing in 2013”, where “a quantity of all taxi passenger trajectories” is a query object and “Chaoyang District in Beijing in 2013” is a query range, the query corresponds to a particular spatial-temporal area in a spatial-temporal database. As shown in FIG. 3, the following steps are performed.

1000: Establish, in advance, a spatial-temporal index and an inverted index for a database that stores taxi trajectory data.

The spatial index is established to determine all index leaf nodes in the database, and the inverted index is established to form a first relationship correspondence table that includes a correspondence between each trajectory and an ID of an index leaf node associated with the trajectory.

1001: Find, according to a received trajectory data query range, a spatial-temporal area q related to “Chaoyang District in Beijing in 2013” in the database that stores the taxi trajectory data.

1002: Calculate a quantity n of all index leaf nodes in the spatial-temporal area q.

1003: Perform random sampling with replacement for all index leaf nodes in the spatial-temporal area, to obtain a quantity B of after-sampling repeatable index leaf nodes, where n>B, and both n and B are positive integers.

Because the random sampling with replacement is used, the B leaf nodes may be repeatable, that is, each sampled leaf node is independently and randomly selected from all the leaf nodes in q. In addition, the quantity of index leaf nodes may be flexibly set by a person skilled in the art according to an actual condition, which is not limited herein in the present application.

1004: List, according to the index leaf nodes obtained by sampling, multiple trajectories included in each index leaf node.

1005: Determine whether a recurring trajectory exists among the multiple trajectories that are listed, and if a trajectory recurs, skip listing the recurring trajectory, to obtain multiple non-repeated trajectories.

1006: Obtain, from the established first relationship correspondence table, an ID of at least one index leaf node associated with each trajectory in the multiple non-repeated trajectories.

1007: Compare the ID of the at least one index leaf node with IDs of the index leaf nodes obtained by sampling, and if the ID of the at least one index leaf node is the same as an ID of an index leaf node among the index leaf nodes obtained by sampling, reserve an index leaf node corresponding to the trajectory, and record, in a second relationship correspondence table, a correspondence between the index leaf node and the trajectory.

1008: Calculate a quantity of index leaf nodes corresponding to each trajectory in the second relationship correspondence table, to obtain kᵣ^{q}.

1009: Substitute the foregoing parameters into the foregoing formula (1) to obtain a calculation result, where the calculation result is a result of the query from the user.

Using the foregoing steps, a query result can be obtained in a very short time, thereby improving query efficiency and saving a system resource.

In addition, when a trajectory data query is a trajectory characteristic query, for example, when a query is “querying total driving distance mileage of all taxi passenger trajectories in Chaoyang District in Beijing in 2013”, on the basis of the foregoing steps 1000 to 1009, a quantity of kilometers corresponding to each trajectory in a second relationship correspondence table is further calculated, that is, the formula (2) may be applied to obtain a result to be queried by a user.

When a trajectory data query object is a query for an average trajectory characteristic value, for example, when a query is “querying an average speed of all taxi passenger trajectories in Chaoyang District in Beijing in 2013”, on the basis of the foregoing steps 1000 to 1009, a quantity of kilometers corresponding to each trajectory in a second relationship correspondence table is further calculated, and the formula (3) is applied to obtain a result to be queried by a user.

### Embodiment 3

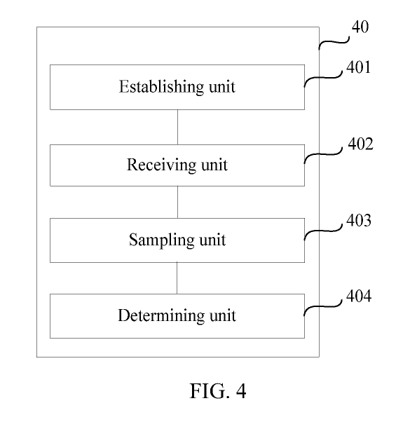

Correspondingly, Embodiment 3 of the present application further provides a trajectory data query apparatus 40. As shown in FIG. 4, the apparatus 40 includes an establishing unit 401 configured to establish a spatial-temporal index and an inverted index for trajectory data in a spatial-temporal database, where the inverted index is used to form a first relationship correspondence table that includes a correspondence between each trajectory and its associated index leaf node, and forms of an association between each trajectory and its associated index leaf node include a middle portion of the trajectory passes through an index leaf node, the beginning or end of the trajectory is in an index leaf node, and the trajectory is completely in an index leaf node; a receiving unit 402 configured to receive a trajectory data query from a user, where the trajectory data query from the user includes specifying, by the user, a space area in the spatial-temporal database, to count a result of data in the space area; a sampling unit 403 configured to perform sampling for an index leaf node included in the specified space area, where a quantity of index leaf nodes in the space area and a quantity of index leaf nodes obtained by sampling are determined; and a determining unit 404 configured to determine, according to the index leaf nodes obtained by sampling by the sampling unit 403 and the first relationship correspondence table, a correspondence between each trajectory included in the index leaf nodes obtained by sampling and an index leaf node associated with the trajectory, to form a second relationship correspondence table, and configured to determine an unbiased estimation operator according to the quantity of index leaf nodes in the space area, the quantity of index leaf nodes obtained by sampling, and data in the second relationship correspondence table, and determine a query result by means of calculation.

In the trajectory data query apparatus 40 provided in Embodiment 3 of the present application, the establishing unit 401 establishes a spatial-temporal index and an inverted index for trajectory data in a spatial-temporal database, where the inverted index is used to form a first relationship correspondence table that includes a correspondence between each trajectory and its associated index leaf node; the receiving unit 402 receives a trajectory data query from a user, where the trajectory data query from the user includes specifying, by the user, a space area in the spatial-temporal database; the sampling unit 403 performs sampling for an index leaf node included in the specified space area, where a quantity of index leaf nodes in the space area and a quantity of index leaf nodes obtained by sampling are determined; and the determining unit 404 determines, according to the index leaf nodes obtained by sampling by the sampling unit 403 and the first relationship correspondence table, a correspondence between each trajectory included in the index leaf nodes obtained by sampling and an index leaf node associated with the trajectory, to form a second relationship correspondence table, and the determining unit 404 further determines an unbiased estimation operator according to the quantity of index leaf nodes in the space area, the quantity of index leaf nodes obtained by sampling, and data in the second relationship correspondence table, and determines a query result by means of calculation. It can be seen from the above that, in the present application, in addition to a spatial-temporal index, the establishing unit 401 also establishes an inverted index. Therefore, the determining unit 404 may determine, according to the two indexes, a correspondence between a trajectory included in index leaf nodes obtained by sampling and an index leaf node associated with the trajectory, that is, form a second relationship correspondence table; and further, the determining unit 404 may determine an unbiased estimation operator according to a quantity of index leaf nodes in a space area, a quantity of index leaf nodes obtained by sampling, and data in the second relationship correspondence table, and determine a query result by means of calculation. The foregoing apparatus 40 that establishes a spatial-temporal index and an inverted index and is based on sampling can avoid scanning all trajectory data in a query-related spatial-temporal area, thereby shortening a query time, improving query efficiency, and saving a system resource. In addition, a query result determined by means of calculation using an unbiased estimation operator has relatively high accuracy.

Optionally, in a specific embodiment of the present application, the establishing unit 401 is configured to determine all index leaf nodes in the spatial-temporal database by means of the spatial-temporal index; determine, based on each trajectory in the spatial-temporal database, an index leaf node associated with each trajectory; and store the correspondence between each trajectory and its associated index leaf node to form the first relationship correspondence table.

Optionally, in a specific embodiment of the present application, the sampling unit 403 is configured to perform random sampling with replacement for n index leaf nodes included in the specified space area, to obtain B repeatable index leaf nodes, where n>B, and both n and B are positive integers. Optionally, in a specific embodiment of the present application, as shown in FIG. 5, the determining unit 404 includes a determining module 4041 configured to list, according to the index leaf nodes obtained by sampling, multiple trajectories included in the index leaf nodes; an obtaining module 4042 configured to obtain, from the first relationship correspondence table, at least one index leaf node associated with each trajectory in the multiple trajectories; and a judging module 4043 configured to determine whether the at least one index leaf node obtained by the obtaining module exists among the index leaf nodes obtained by sampling by the sampling unit, and if a determining result is that the at least one index leaf node obtained by the obtaining module exists among the index leaf nodes obtained by sampling by the sampling unit, reserve an index leaf node corresponding to the trajectory, and record, in the second relationship correspondence table, a correspondence between the index leaf node and the trajectory.

Further, in a specific embodiment of the present application, the determining module 4041 is further configured to determine whether a recurring trajectory exists among the multiple trajectories that are listed, and if a trajectory recurs, skip listing the recurring trajectory, to ensure that multiple non-repeated trajectories are obtained; and in this case, the obtaining module 4042 is configured to obtain, from the first relationship correspondence table, at least one index leaf node associated with each trajectory in the multiple non-repeated trajectories determined by the determining module.

Optionally, in a specific embodiment of the present application, the determining unit 404 is configured to calculate a quantity of index leaf nodes corresponding to each trajectory in the second relationship correspondence table; and determine the unbiased estimation operator according to the quantity of index leaf nodes in the space area, the quantity of index leaf nodes obtained by sampling, a quantity of trajectories in the second relationship correspondence table, and a quantity of corresponding index leaf nodes that each trajectory passes through in the spatial-temporal area, and with reference to a probability statistical method and a law of large numbers, and determine the query result by means of calculation according to the unbiased estimation operator, where the determining the unbiased estimation operator with reference to a probability statistical method and a law of large numbers is determining a real value expression that includes information about all the leaf nodes in the specified area; and then, performing sampling for all the leaf nodes in the specified area, and determining the unbiased estimation operator using information about the leaf nodes obtained by sampling, and with reference to the law of large numbers, to estimate a real value obtained using the real value expression.

It should be noted that, for a specific function of each structural unit of the trajectory data query apparatus 40 provided in Embodiment 3 of the present application, refer to the foregoing method Embodiment 1 or 2.

### Embodiment 4

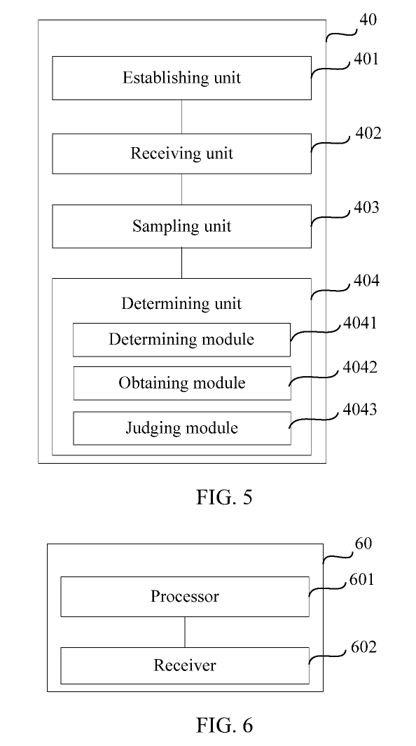

Correspondingly, Embodiment 4 of the present application further provides a trajectory data query apparatus 60. As shown in FIG. 6, the apparatus 60 includes a processor 601 configured to establish a spatial-temporal index and an inverted index for trajectory data in a spatial-temporal database, where the inverted index is used to form a first relationship correspondence table that includes a correspondence between each trajectory and its associated index leaf node, and forms of an association between each trajectory and its associated index leaf node include a middle portion of the trajectory passes through an index leaf node, the beginning or end of the trajectory is in an index leaf node, and the trajectory is completely in an index leaf node; and a receiver 602 configured to receive a trajectory data query from a user, where the trajectory data query from the user includes specifying, by the user, a space area in the spatial-temporal database, to count a result of data in the space area, where the processor 601 is further configured to perform sampling for an index leaf node included in the specified space area, where a quantity of index leaf nodes in the space area and a quantity of index leaf nodes obtained by sampling are determined, and determine, according to the index leaf nodes obtained by sampling and the first relationship correspondence table, a correspondence between each trajectory included in the index leaf nodes obtained by sampling and an index leaf node associated with the trajectory, to form a second relationship correspondence table; and configured to determine an unbiased estimation operator according to the quantity of index leaf nodes in the space area, the quantity of index leaf nodes obtained by sampling, and data in the second relationship correspondence table, and determine a query result by means of calculation.

In the trajectory data query apparatus 60 provided in Embodiment 4 of the present application, the processor 601 establishes a spatial-temporal index and an inverted index for trajectory data in a spatial-temporal database, where the inverted index is used to form a first relationship correspondence table that includes a correspondence between each trajectory and its associated index leaf node; and when the receiver 602 receives a trajectory data query from a user, where the trajectory data query from the user includes specifying, by the user, a space area in the spatial-temporal database, the processor 601 performs sampling for an index leaf node included in the specified space area, where a quantity of index leaf nodes in the space area and a quantity of index leaf nodes obtained by sampling are determined, determines, according to the index leaf nodes obtained by sampling and the first relationship correspondence table, a correspondence between each trajectory included in the index leaf nodes obtained by sampling and an index leaf node associated with the trajectory, to form a second relationship correspondence table, and further determines a query result according to the quantity of index leaf nodes in the space area, the quantity of index leaf nodes obtained by sampling, and data in the second relationship correspondence table. It can be seen from the above that, in the present application, in addition to a spatial-temporal index, the processor 601 also establishes an inverted index. Therefore, according to the two indexes, a correspondence between a trajectory included in index leaf nodes obtained by sampling and an index leaf node associated with the trajectory can be determined, that is, a second relationship correspondence table is formed; and further an unbiased estimation operator can be determined according to a quantity of index leaf nodes in a space area, a quantity of index leaf nodes obtained by sampling, and data in the second relationship correspondence table, and a query result can be determined by means of calculation. The foregoing apparatus 60 that establishes a spatial-temporal index and an inverted index and is based on sampling can avoid scanning all trajectory data in a query-related spatial-temporal area, thereby shortening a query time, improving query efficiency, and saving a system resource. In addition, a query result determined by means of calculation using an unbiased estimation operator has relatively high accuracy.

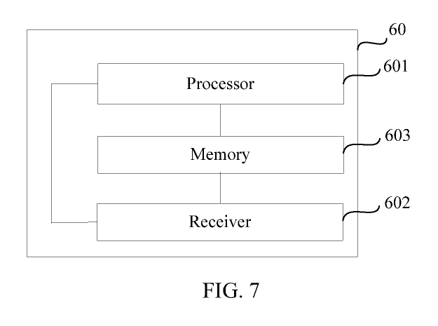

Optionally, in a specific embodiment of the present application, as shown in FIG. 7, the processor 601 is configured to determine all index leaf nodes in the spatial-temporal database by means of the spatial-temporal index, and determine, based on each trajectory in the database, an index leaf node associated with each trajectory; and a memory 603 is configured to store the correspondence between each trajectory and its associated index leaf node to form the first relationship correspondence table.

Optionally, in a specific embodiment of the present application, the processor 601 is configured to perform random sampling with replacement for n index leaf nodes included in the specified space area, to obtain B repeatable index leaf nodes, where n>B, and both n and B are positive integers.

Optionally, in a specific embodiment of the present application, the processor 601 is configured to list, according to the index leaf nodes obtained by sampling, multiple trajectories included in the index leaf nodes; obtain, from the first relationship correspondence table, at least one index leaf node associated with each trajectory in the multiple trajectories; and determine whether the at least one index leaf node obtained by the processor 601e exists among the index leaf nodes obtained by sampling, and if a determining result is that the at least one index leaf node obtained by the processor 601 exists among the index leaf nodes obtained by sampling, reserve an index leaf node corresponding to the trajectory, and record, in the second relationship correspondence table, a correspondence between the index leaf node and the trajectory.

Optionally, in a specific embodiment of the present application, the processor 601 is configured to determine whether a recurring trajectory exists among the multiple trajectories that are listed, and if a trajectory recurs, skip listing the recurring trajectory, to ensure that multiple non-repeated trajectories are obtained; and obtain, from the first relationship correspondence table, at least one index leaf node associated with each trajectory in the multiple non-repeated trajectories determined by the processor 601.

Optionally, in a specific embodiment of the present application, the processor 601 is configured to calculate a quantity of index leaf nodes corresponding to each trajectory in the second relationship correspondence table; and determine the unbiased estimation operator according to the quantity of index leaf nodes in the space area, the quantity of index leaf nodes obtained by sampling, a quantity of trajectories in the second relationship correspondence table, and a quantity of corresponding index leaf nodes that each trajectory passes through in the spatial-temporal area, and with reference to a probability statistical method and a law of large numbers, and determine the query result by means of calculation according to the unbiased estimation operator, where the determining the unbiased estimation operator with reference to a probability statistical method and a law of large numbers is determining a real value expression that includes information about all the leaf nodes in the specified area; and then, performing sampling for all the leaf nodes in the specified area, and determining the unbiased estimation operator using information about the leaf nodes obtained by sampling, and with reference to the law of large numbers, to estimate a real value obtained using the real value expression.

It should be noted that, for a specific function of each structural unit of the trajectory data query apparatus 60 provided in Embodiment 4 of the present application, refer to the foregoing method Embodiment 1 or 2.

A person of ordinary skill in the art may understand that all or some of the steps of the methods in the embodiments may be implemented by a program instructing relevant hardware. The program may be stored in a computer-readable storage medium. The storage medium may be a read-only memory, a magnetic disc, an optical disc, or the like.

The foregoing descriptions are merely specific implementation manners of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A trajectory data query method, comprising:
establishing a spatial-temporal index and an inverted index for trajectory data in a spatial-temporal database, wherein the inverted index is used to form a first relationship correspondence table that comprises a correspondence between each trajectory and its associated index leaf node, and wherein the inverted index forms of an association between each trajectory and its associated index leaf node comprises a middle portion of the trajectory passes through an index leaf node, a beginning or an end of the trajectory is in an index leaf node, and the trajectory is completely in an index leaf node;
receiving a trajectory data query from a user, wherein the trajectory data query from the user comprises specifying, by the user, a space area in the spatial-temporal database, to count a result of data in the space area;
performing sampling for an index leaf node comprised in the specified space area;
obtaining a quantity of index leaf nodes in the space area and a quantity of index leaf nodes obtained by sampling;
obtaining, according to the index leaf nodes obtained by sampling and the first relationship correspondence table, a correspondence between each trajectory comprised in the index leaf nodes obtained by sampling and an index leaf node associated with the trajectory in order to form a second relationship correspondence table;
determining an unbiased estimation operator according to the quantity of index leaf nodes in the space area, the quantity of index leaf nodes obtained by sampling, and data in the second relationship correspondence table; and
obtaining a query result by means of calculation.

2. The method according to claim 1, wherein forming the first relationship correspondence table that comprises a correspondence between each trajectory and its associated index leaf node comprises:
obtaining all index leaf nodes in the spatial-temporal database by means of the spatial-temporal index;
obtaining, based on each trajectory in the spatial-temporal database, an index leaf node associated with each trajectory; and
storing the correspondence between each trajectory and its associated index leaf node to form the first relationship correspondence table.

3. The method according to claim 1 wherein performing sampling for the index leaf node comprised in the space area, wherein the quantity of index leaf nodes in the space area and the quantity of index leaf nodes obtained by sampling are determined, comprises performing random sampling with replacement for n index leaf nodes comprised in the specified space area in order to obtain B repeatable index leaf nodes, wherein n>B, and wherein both n and B are positive integers.

4. The method according to claim 1, wherein obtaining, according to the index leaf nodes obtained by sampling and the first relationship correspondence table, the correspondence between each trajectory comprised in the index leaf nodes obtained by sampling and the index leaf node associated with the trajectory in order to form the second relationship correspondence table comprises:
listing, according to the index leaf nodes obtained by sampling, multiple trajectories comprised in the index leaf nodes;
obtaining, from the first relationship correspondence table, at least one index leaf node associated with each trajectory in the multiple trajectories; and
reserving an index leaf node corresponding to the trajectory when the at least one index leaf node exists among the index leaf nodes obtained by sampling; and
recording, in the second relationship correspondence table, a correspondence between the index leaf node and the trajectory.

5. The method according to claim 4, wherein after listing, according to the index leaf nodes obtained by sampling, the multiple trajectories comprised in the index leaf nodes, the method further comprises:
determining whether a recurring trajectory exists among the multiple trajectories that are listed; and
skipping listing the recurring trajectory, when a trajectory recurs, to ensure that multiple non-repeated trajectories are obtained,
wherein obtaining, from the first relationship correspondence table, at least one index leaf node associated with each trajectory in the multiple trajectories comprises obtaining, from the first relationship correspondence table, at least one index leaf node associated with each trajectory in the multiple non-repeated trajectories.

6. The method according to claim 1, wherein determining the unbiased estimation operator according to the quantity of index leaf nodes in the space area, the quantity of index leaf nodes obtained by sampling, and data in the second relationship correspondence table, and determining the query result by means of calculation comprises:
calculating a quantity of index leaf nodes corresponding to each trajectory in the second relationship correspondence table;
determining the unbiased estimation operator according to the quantity of index leaf nodes in the space area, the quantity of index leaf nodes obtained by sampling, a quantity of trajectories in the second relationship correspondence table, and a quantity of corresponding index leaf nodes that each trajectory passes through in a spatial-temporal area, and with reference to a probability statistical method and a law of large numbers; and
obtaining the query result by means of calculation according to the unbiased estimation operator,
wherein the determining the unbiased estimation operator with reference to a probability statistical method and a law of large numbers comprises:
obtaining a real value expression that comprises information about all the leaf nodes in the specified space area;
performing sampling for all the leaf nodes in the specified space area; and
determining the unbiased estimation operator using information about the leaf nodes obtained by sampling, and with reference to the law of large numbers, to estimate a real value obtained using the real value expression.

7. The method according to claim 6, wherein when the trajectory data query from the user is a trajectory count query, the following unbiased estimation operator is determined, and a query result is determined by means of calculation:
$${\hat{N}}_{q} = \frac{n}{B} {\sum }_{t = 1}^{B} {f}_{q} {( {R}_{t} )}^{{\hat{}}^{q}} , \\ wherein {f}_{q} {( {R}_{t} )}^{{\hat{}}^{q}} = {\sum }_{r ∈ {{R}_{t}}^{{\hat{}}^{q}} \hat{} q} \{ 1 / {k}_{r}^{q} \} ,$$
wherein q represents a spatial-temporal area related to a query range of the user wherein n represents a quantity of all index leaf nodes in the spatial-temporal area q before sampling, wherein B represents a quantity of index leaf nodes after the sampling when the trajectory data query from the user is a trajectory count query, wherein r represents a trajectory obtained according to the B index leaf nodes and a second relationship correspondence table obtained after the sampling, and wherein kᵣ^{q} represents a quantity of index leaf nodes that the trajectory r passes through in the queried spatial-temporal area q.

8. The method according to claim 6, wherein when the trajectory data query from the user is a trajectory characteristic query, the following unbiased estimation operator is determined, and a query result is determined by means of calculation:
$${\hat{l}}_{q} = \frac{n}{B} {\sum }_{t = 1}^{B} {h}_{q} {( {R}_{t} )}^{{\hat{}}^{q}} , \\ wherein {h}_{q} {( {R}_{t} )}^{{\hat{}}^{q}} = {\sum }_{r ∈ {{R}_{t}}^{{\hat{}}^{q}}} {l}_{r} / {k}_{r}^{q} ,$$
wherein q represents a spatial-temporal area related to a query range of the user, wherein n represents a quantity of all index leaf nodes in the spatial-temporal area q before sampling, wherein B represents a quantity of index leaf nodes after the sampling, wherein r represents a trajectory obtained according to the B index leaf nodes and a second relationship correspondence table obtained after the sampling, wherein lᵣ represents a trajectory characteristic of the trajectory r, and wherein kᵣ^{q} represents a quantity of index leaf nodes that the trajectory r passes through in the queried spatial-temporal area q.

9. The method according to claim 6, wherein when the trajectory data query from the user is a query for an average trajectory characteristic value, the following unbiased estimation operator is determined, and a query result is determined by means of calculation:
$${\hat{L}}_{q} = \frac{{\sum }_{t = 1}^{B} {h}_{q} {( {R}_{t} )}^{{\hat{}}^{q}}}{{\sum }_{t = 1}^{B} {f}_{q} {( {R}_{t} )}^{{\hat{}}^{q}}} , wherein$$
$${\hat{N}}_{q} = {f}_{q} {( {R}_{t} )}^{{\hat{}}^{q}} = {\sum }_{r ∈ {{R}_{t}}^{{\hat{}}^{q}} \hat{} q} \{ 1 / {k}_{r}^{q} \} , {h}_{q} {( {R}_{t} )}^{{\hat{}}^{q}} = {\sum }_{r ∈ {{R}_{t}}^{{\hat{}}^{q}}} {l}_{r} / {k}_{r}^{q} ,$$
wherein q represents a spatial-temporal area related to a query range of the user, wherein n represents a quantity of index leaf nodes in the spatial-temporal area q before sampling, wherein B represents a quantity of index leaf nodes after the sampling, wherein r represents a trajectory obtained according to the B index leaf nodes and a second relationship correspondence table obtained after the sampling, wherein lᵣ represents a trajectory characteristic of the trajectory r, and wherein kᵣ^{q} represents a quantity of index leaf nodes that the trajectory r passes through in the queried spatial-temporal area q.

10. A trajectory data query apparatus, comprising:
an establishing unit configured to establish a spatial-temporal index and an inverted index for trajectory data in a spatial-temporal database, wherein the inverted index is used to form a first relationship correspondence table that comprises a correspondence between each trajectory and its associated index leaf node, and forms of an association between each trajectory and its associated index leaf node comprise a middle portion of the trajectory passes through an index leaf node, a beginning or an end of the trajectory is in an index leaf node, and the trajectory is completely in an index leaf node;
a receiving unit, configured to receive a trajectory data query from a user, wherein the trajectory data query from the user comprises specifying, by the user, a space area in the spatial-temporal database in order to count a result of data in the space area;
a sampling unit configured to perform sampling for an index leaf node comprised in the specified space area, wherein a quantity of index leaf nodes in the space area and a quantity of index leaf nodes obtained by sampling are determined; and
a determining unit configured to:
determine, according to the index leaf nodes obtained by sampling by the sampling unit and the first relationship correspondence table, a correspondence between each trajectory comprised in the index leaf nodes obtained by sampling and an index leaf node associated with the trajectory in order to form a second relationship correspondence table;
determine an unbiased estimation operator according to the quantity of index leaf nodes in the space area, the quantity of index leaf nodes obtained by sampling, and data in the second relationship correspondence table; and
determine a query result by means of calculation.

11. The apparatus according to claim 10, wherein the establishing unit is further configured to:
determine all index leaf nodes in the spatial-temporal database by means of the spatial-temporal index;
determine, based on each trajectory in the spatial-temporal database, an index leaf node associated with each trajectory; and
store the correspondence between each trajectory and its associated index leaf node to form the first relationship correspondence table.

12. The apparatus according to claim 10, wherein the sampling unit is further configured to perform random sampling with replacement for n index leaf nodes comprised in the specified space area in order to obtain B repeatable index leaf nodes, wherein n>B, and wherein both n and B are positive integers.

13. The apparatus according to claim 10, wherein the determining unit comprises:
a determining module configured to list, according to the index leaf nodes obtained by sampling, multiple trajectories comprised in the index leaf nodes;
an obtaining module configured to obtain, from the first relationship correspondence table, at least one index leaf node associated with each trajectory in the multiple trajectories; and
a judging module configured to:
determine whether the at least one index leaf node obtained by the obtaining module exists among the index leaf nodes obtained by sampling by the sampling unit, and
reserve an index leaf node corresponding to the trajectory when a determining result is that the at least one index leaf node obtained by the obtaining module exists among the index leaf nodes obtained by sampling by the sampling unit; and
record, in the second relationship correspondence table, a correspondence between the index leaf node and the trajectory.

14. The apparatus according to claim 13, wherein the determining module is further configured to:
determine whether a recurring trajectory exists among the multiple trajectories that are listed; and
skip listing the recurring trajectory, when a trajectory recurs, to ensure that multiple non-repeated trajectories are obtained, and
wherein the obtaining module is configured to obtain, from the first relationship correspondence table, at least one index leaf node associated with each trajectory in the multiple non-repeated trajectories determined by the determining module.

15. The apparatus according to claim 10, wherein the determining unit is further configured to:
calculate a quantity of index leaf nodes corresponding to each trajectory in the second relationship correspondence table;
determine the unbiased estimation operator according to the quantity of index leaf nodes in the space area, the quantity of index leaf nodes obtained by sampling, a quantity of trajectories in the second relationship correspondence table, and a quantity of corresponding index leaf nodes that each trajectory passes through in a spatial-temporal area, and with reference to a probability statistical method and a law of large numbers; and
determine the query result by means of calculation according to the unbiased estimation operator,
wherein determining the unbiased estimation operator with reference to a probability statistical method and a law of large numbers comprises:
determining a real value expression that comprises information about all the leaf nodes in the specified space area;
performing sampling for all the leaf nodes in the specified space area; and
determining the unbiased estimation operator using information about the leaf nodes obtained by sampling, and with reference to the law of large numbers, to estimate a real value obtained using the real value expression.

16. A trajectory data query apparatus, comprising:
a processor configured to establish a spatial-temporal index and an inverted index for trajectory data in a spatial-temporal database, wherein the inverted index is used to form a first relationship correspondence table that comprises a correspondence between each trajectory and its associated index leaf node, and forms of an association between each trajectory and its associated index leaf node comprise a middle portion of the trajectory passes through an index leaf node, a beginning or an end of the trajectory is in an index leaf node, and the trajectory is completely in an index leaf node; and
a receiver coupled to the processor and configured to receive a trajectory data query from a user, wherein the trajectory data query from the user comprises specifying, by the user, a space area in the spatial-temporal database in order to count a result of data in the space area,
wherein the processor is further configured to:
perform sampling for an index leaf node comprised in the specified space area, wherein a quantity of index leaf nodes in the space area and a quantity of index leaf nodes obtained by sampling are determined;
determine, according to the index leaf nodes obtained by sampling and the first relationship correspondence table, a correspondence between each trajectory comprised in the index leaf nodes obtained by sampling and an index leaf node associated with the trajectory in order to form a second relationship correspondence table;
configured to determine an unbiased estimation operator according to the quantity of index leaf nodes in the space area, the quantity of index leaf nodes obtained by sampling, and data in the second relationship correspondence table; and
determine a query result by means of calculation.

17. The apparatus according to claim 16, wherein the processor is further configured to:
determine all index leaf nodes in the spatial-temporal database by means of the spatial-temporal index;
determine, based on each trajectory in the spatial-temporal database, an index leaf node associated with each trajectory; and
store the correspondence between each trajectory and its associated index leaf node to form the first relationship correspondence table.

18. The apparatus according to claim 16, wherein the processor is further configured to perform random sampling with replacement for n index leaf nodes comprised in the specified space area in order to obtain B repeatable index leaf nodes, wherein n>B, and wherein both n and B are positive integers.

19. The apparatus according to claim 16, wherein the processor is further configured to:
list, according to the index leaf nodes obtained by sampling, multiple trajectories comprised in the index leaf nodes;
obtain, from the first relationship correspondence table, at least one index leaf node associated with each trajectory in the multiple trajectories;
determine whether the at least one index leaf node obtained exists among the index leaf nodes obtained by sampling;
reserve an index leaf node corresponding to the trajectory when a determining result is that the at least one index leaf node exists among the index leaf nodes obtained by sampling; and
record, in the second relationship correspondence table, a correspondence between the index leaf node and the trajectory.

20. The apparatus according to claim 19, wherein the processor is further configured to:
determine whether a recurring trajectory exists among the multiple trajectories that are listed;
skip listing the recurring trajectory, when a trajectory recurs, to ensure that multiple non-repeated trajectories are obtained; and
obtain, from the first relationship correspondence table, at least one index leaf node associated with each trajectory in the multiple non-repeated trajectories.
